(19) United States
(12) Patent Application Publication
(10) Pub. No.: US 2021/0022539 A1
(43) Pub. Date: Jan. 28, 2021

(54) STEAM DISPERSER AND STEAMER HAVING SAME

(71) Applicant: Yongfeng Li, Jiangmen (CN)

(72) Inventor: Yongfeng Li, Jiangmen (CN)

(21) Appl. No.: 16/521,718

(22) Filed: Jul. 25, 2019

(51) Int. Cl. A47J 27/04; A47J 36/02; A47J 36/20

(52) U.S. Cl. CPC A47J 27/04; A47J 2027/043; A47J 36/20; A47J 36/02

(57) ABSTRACT

The present invention discloses a steam disperser and a steamer having the same, comprising a steamer grid bottom plate and a steamer grid tube vertically connected with the steamer grid bottom plate. The steamer grid tube is positioned in the middle position of the steamer grid bottom plate; and a plurality of through vent holes are formed on the tube wall of the steamer grid tube and the steamer grid bottom plate. The present invention is provided with the steamer grid tube with a plurality of vent holes in the middle position of an original one-piece gas steamer grid. During use, steam and heat can be evenly distributed around food from bottom to top through the steamer grid tube to allow all the food on the steamer grid bottom plate to be evenly heated and cooked.

### TECHNICAL FIELD

The present invention relates to the technical field of kitchenware, and particularly to a steam disperser and a steamer having the same.

### BACKGROUND

“Steaming” is a process of cooking food through vapor heating. Because the food is not directly in contact with water, the nutritional value of the food is preserved in the food and is difficult to be destroyed, which maintains the original taste of the food and makes the good delicious. A steamer grid is a tool that must be used during the steaming of the food.

The existing steamer grid is used by placing a piece of steamer grid in the lower middle end of cookware or stockpot and placing a large amount of food on the steamer grid. When the food is steamed, steam and heat firstly pass through the food at a lower layer and then gradually rise to the food at a middle layer and a top layer, which will cause that the food is unevenly heated and the food at the bottom layer is often cooked while the food at the middle and the upper layers is not cooked.

Therefore, how to develop a steamer grid structure to allow the steam to be evenly distributed around the food and all the food to be evenly heated and cooked is a direction to be researched by those skilled in the art currently.

### SUMMARY

The present invention aims to solve one of the above technical problems in the prior art at least to a certain extent.

For this reason, one purpose of the present invention is to propose a steam disperser. The following technical solution is specifically adopted:

The steam disperser comprises a steamer grid bottom plate and a steamer grid tube vertically connected with the steamer grid bottom plate. The steamer grid tube is positioned in the middle position of the steamer grid bottom plate; and a plurality of through vent holes are formed on the tube wall of the steamer grid tube and the steamer grid bottom plate.

The present invention is provided with the steamer grid tube with a plurality of vent holes in the middle position of an original one-piece gas steamer grid. During use, steam and heat can be evenly distributed around food from bottom to top through the steamer grid tube to allow all the food on the steamer grid bottom plate to be evenly heated and cooked.

On the basis of the above technical solution, the present invention can also be improved as follows:

Preferably, the steamer grid tube and the steamer grid bottom plate are fixedly or detachably connected. A user can select an integral steam disperser or a split steam disperser according to different steamer structures.

Preferably, a bulge with a hollow structure is arranged in the middle position of the steamer grid bottom plate, and the end part of the steamer grid tube is adapted and sleeved with the bulge. Steam and heat enter the steamer grid tube through the hollow bulge on the steamer grid bottom plate, and are dispersed and evenly distributed around the food through the vent holes on the steamer grid tube to allow all the food on the steamer grid bottom plate to be evenly heated.

Preferably, the steamer grid tube has a diameter of 2.0 to 3.0 cm and a length of 12 to 44 cm, and the bulge has a diameter of 1.6 to 2.5 cm.

Preferably, the vent holes on the tube wall of the steamer grid tube are evenly distributed so that the steam and the heat can also be dispersed and evenly distributed around the food.

Preferably, the vent holes on the tube wall of the steamer grid tube have a diameter of 3 to 7 mm.

Preferably, the vent holes on the steamer grid bottom plate are distributed in a uniform form or in a form of sparseness in the middle and denseness at the periphery, or in a form of vent holes in other prior art to adapt to steaming of different kinds of food.

Preferably, the steamer grid tube and the steamer grid bottom plate are made of aluminum or stainless steel material.

Preferably, the bottom of the steamer grid bottom plate is provided with a bracket for supporting.

Another purpose of the present invention is to propose a steamer, comprising a steamer body, a steamer cover and a steam disperser which is the above mentioned steam disperser.

It can be known from the above-mentioned technical solution that compared with the prior art, the present invention discloses and provides a steam disperser which is especially suitable for cookware and stockpot. When the steam disperser is used for steaming the food in cookware and stockpot, the steam can be evenly distributed around the food from bottom to top to allow all the food to be evenly heated and cooked, thereby overcoming the problem that the upper food is poorly heated due to the fact that the steam and the heat on the bottom of the traditional one-piece steamer grid are transferred layer by layer from bottom to top, and further improving the taste and the nutritional value of the food.

### DESCRIPTION OF DRAWINGS

To more clearly describe the technical solution in the embodiments of the present invention or in the prior art, the drawings required to be used in the description of the embodiments or the prior art will be simply presented below. Apparently, the drawings in the following description are merely the embodiments of the present invention, and for those ordinary skilled in the art, other drawings can also be obtained according to the provided drawings without contributing creative labor.

FIG. 1 is a schematic diagram of an integral structure of a steam disperser in an embodiment provided by the present invention;

FIG. 2 is a schematic diagram of a split structure of a steam disperser in an embodiment provided by the present invention;

FIG. 3 is a schematic diagram of an integral structure of a steam disperser in another embodiment provided by the present invention; and

FIG. 4 is a structural schematic diagram of a steamer having a steam disperser in an embodiment provided by the present invention.

Wherein in the figures,

1—steamer grid bottom plate; 2—steamer grid tube; 3—vent hole; 4—bulge; and 5—bracket.

### DETAILED DESCRIPTION

The technical solution in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention.

It should be noted in the description of the present invention that terms such as “central”, “upper”, “lower”, “left”, “right”, “vertical”, “horizontal”, “inner”, “outer”, etc. indicate direction or position relationships shown based on the drawings, and are only intended to facilitate the description of the present invention and the simplification of the description rather than to indicate or imply that the indicated device or element must have a specific direction or constructed and operated in a specific direction, and therefore, shall not be understood as a limitation to the present invention. In addition, the terms such as “first”, “second” and “third” are only used for the purpose of description, rather than being understood to indicate or imply relative importance.

It should be noted in the description of the present invention that, unless otherwise specifically regulated and defined, terms such as “installation,” “connected,” and “connecting” shall be understood in broad sense, and for example, may refer to fixed connection or detachable connection or integral connection, may refer to mechanical connection or electrical connection, and may refer to direct connection or indirect connection through an intermediate medium or inner communication of two elements. For those ordinary skilled in the art, the meanings of the above terms in the present invention may be understood according to specific conditions.

### Embodiment

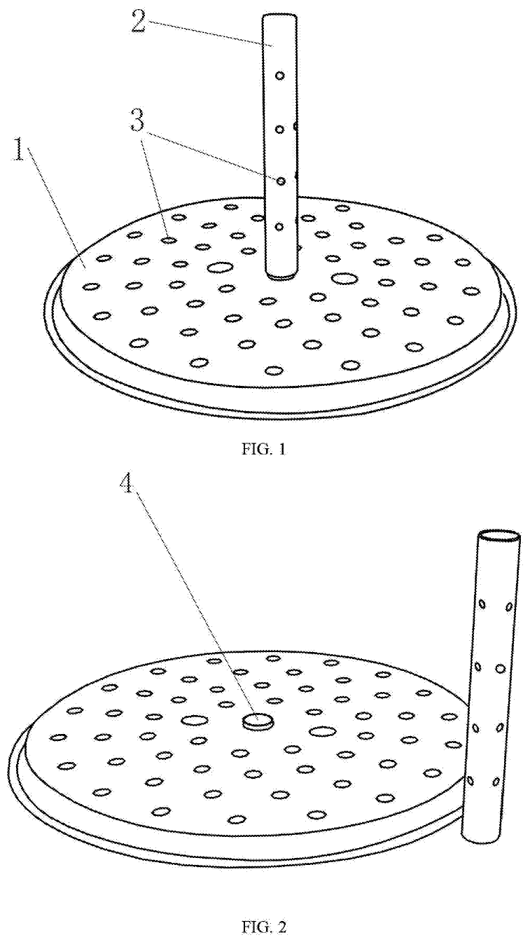

A steam disperser according to the embodiment of the present invention is described below in detail with reference to FIG. 1 to FIG. 4.

As shown in FIG. 1 to FIG. 4, the embodiment of the present invention discloses a steam disperser which specifically comprises a steamer grid bottom plate 1 and a steamer grid tube 2 vertically connected with the steamer grid bottom plate 1. The steamer grid tube 2 is positioned in the middle position of the steamer grid bottom plate 1; and a plurality of through vent holes 3 are formed on the tube wall of the steamer grid tube 2 and the steamer grid bottom plate 1.

The vent holes 3 have a shape of a circle, or may have a shape of a long strip or other common shapes that are easily contemplated by those skilled in the art, which will not be described again.

To further optimize the technical solution of the above embodiment, the steamer grid tube 2 is fixedly or detachably connected with the steamer grid bottom plate 1. The integral structure has the advantages of firm connection and convenient use. The split structure has the advantages of convenient storage and convenient matching use of different kinds of steamer grid bottom plates 1 and steamer grid tubes 2. A user can select an integral steam disperser or a split steam disperser according to different steamer structures and personal preference.

To further optimize the technical solution of the above embodiment, a bulge 4 with a hollow structure can be additionally arranged in the middle position of the steamer grid bottom plate 1, and the end part of the steamer grid tube 2 is adapted, sleeved and inserted with the bulge 4. Steam and heat enter the steamer grid tube 2 through the hollow bulge 4 on the steamer grid bottom plate 1, and are dispersed and evenly distributed around the food through the vent holes 3 on the steamer grid tube 2 to allow all the food on the steamer grid bottom plate 1 to be evenly heated.

A fixing hole can also be formed in the middle position of the steamer grid bottom plate 1. The end part of the steamer grid tube 2 is adapted and inserted into the fixing hole to fix the steamer grid bottom plate 1 and the steamer grid tube 2. In addition, other connection forms of the steamer grid bottom plate and the steamer grid tube that can be contemplated by those skilled in the art are also within the protection scope of the present invention.

To further optimize the technical solution of the above embodiment, the steamer grid tube 2 has a diameter of 2.0 to 3.0 cm, and preferably 2.3 cm, and has a length of 12 to 44 cm, and preferably 20 cm. The bulge 4 has a diameter of 1.6 to 2.5 cm, and preferably 2 cm.

To further optimize the technical solution of the above embodiment, the vent holes 3 on the tube wall of the steamer grid tube 2 are evenly distributed so that the steam and the heat can also be dispersed and evenly distributed around the food.

To further optimize the technical solution of the above embodiment, the vent holes 3 on the tube wall of the steamer grid tube 2 have a diameter of 3 to 7 mm, and preferably 3 mm.

To further optimize the technical solution of the above embodiment, the vent holes 3 on the steamer grid bottom plate 1 are distributed in a uniform form or in a form of sparseness in the middle and denseness at the periphery, or in a form of vent holes 3 in other prior art to adapt to steaming of different kinds of food. All or most of the vent holes 3 on the steamer grid bottom plate 1 have a diameter of 1 to 1.4 cm, and preferably 1.2 cm.

To further optimize the technical solution of the above embodiment, the steamer grid tube 2 and the steamer grid bottom plate 1 are made of aluminum or stainless steel material.

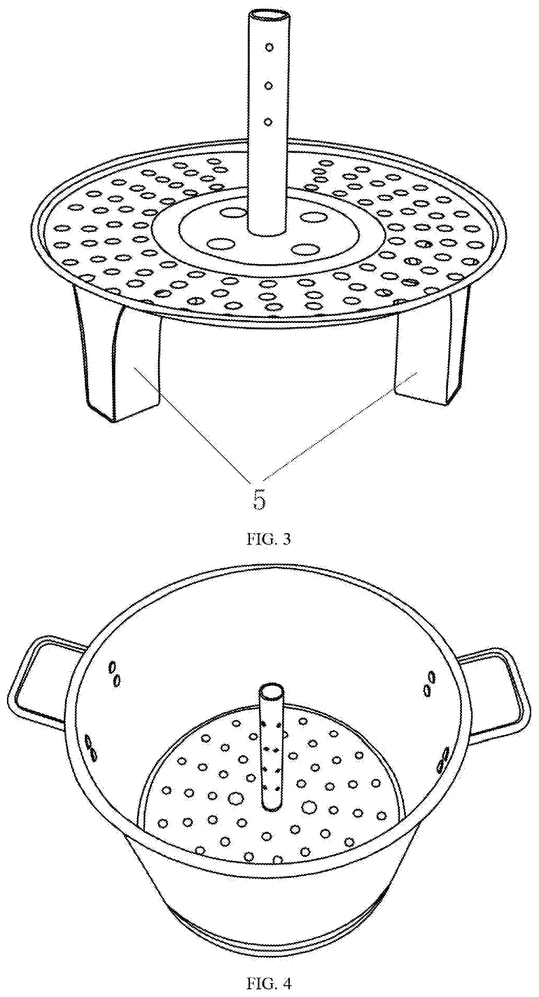

To further optimize the technical solution of the above embodiment, as shown in FIG. 3, the bottom of the steamer grid bottom plate 1 is provided with a bracket 5 for supporting.

The bracket 5 may be a plurality of legs evenly distributed at the bottom of the steamer grid bottom plate. The number of the legs may be determined according to actual conditions, and may be two, three, four or more. In addition, other bracket structures for supporting in the prior art are also within the protection scope of the present invention.

The embodiment of the present invention also proposes a steamer, comprising a steamer body, a steamer cover and a steam disperser which is the above mentioned steam disperser.

The following is a specific manufacturing method of one embodiment of the steam disperser of the present invention:

1. Tubular material made of aluminum or stainless steel is used to uniformly punch a plurality of small holes around the tubular material as gas-permeable and heat-permeable holes (vent holes 3) to prepare the steamer grid tube 2.

2. Sheet material made of aluminum or stainless steel is prepared into a round sheet, and a plurality of small holes are uniformly punched as gas-permeable and heat-permeable holes (vent holes 3) to prepare the steamer grid bottom plate 1. At the same time, a bulge 4 is punched in the central position of the steamer grid bottom plate 1 for connecting and fixing the steamer grid tube 2.

3. During use, the steamer grid tube 2 is inserted into a connecting port of the middle hollow bulge 4 of the steamer grid bottom plate 1 and is fixed. When the food is steamed, the steamer grid tube 2 can play a role.

Each embodiment in the description is described in a progressive way. The difference of each embodiment from each other is the focus of explanation. The same and similar parts among all of the embodiments can be referred to each other. For the device disclosed by the embodiments, because the device corresponds to a method disclosed by the embodiments, the device is simply described. Refer to the description of the method part for the related part.

The above description of the disclosed embodiments enables those skilled in the art to realize or use the present invention. Many modifications to these embodiments will be apparent to those skilled in the art. The general principle defined herein can be realized in other embodiments without departing from the spirit or scope of the present invention. Therefore, the present invention will not be limited to these embodiments shown herein, but will conform to the widest scope consistent with the principle and novel features disclosed herein.

1. A steam disperser, characterized by comprising a steamer grid bottom plate (1) and a steamer grid tube (2) vertically connected with the steamer grid bottom plate (1), wherein the steamer grid tube (2) is positioned in the middle position of the steamer grid bottom plate (1); and a plurality of through vent holes (3) are formed on the tube wall of the steamer grid tube (2) and the steamer grid bottom plate (1).

2. The steam disperser according to claim 1, characterized in that the steamer grid tube (2) is fixedly or detachably connected with the steamer grid bottom plate (1).

3. The steam disperser according to claim 2, characterized in that a bulge (4) with a hollow structure is arranged in the middle position of the steamer grid bottom plate (1), and the end part of the steamer grid tube (2) is adapted and sleeved with the bulge (4).

4. The steam disperser according to claim 3, characterized in that the steamer grid tube (2) has a diameter of 2.0 to 3.0 cm and a length of 12 to 44 cm, and the bulge (4) has a diameter of 1.6 to 2.5 cm.

5. The steam disperser according to claim 1, characterized in that the vent holes (3) on the tube wall of the steamer grid tube (2) are distributed in a uniform form.

6. The steam disperser according to claim 1, characterized in that the vent holes (3) on the tube wall of the steamer grid tube (2) have a diameter of 3 to 7 mm.

7. The steam disperser according to claim 1, characterized in that the vent holes (3) on the steamer grid bottom plate (1) are distributed in a uniform form or in a form of sparseness in the middle and denseness at the periphery.

8. The steam disperser according to claim 1, characterized in that the steamer grid tube (2) and the steamer grid bottom plate (1) are made of aluminum or stainless steel material.

9. The steam disperser according to claim 1, characterized in that the bottom of the steamer grid bottom plate (1) is provided with a bracket (4) for supporting.

10. A steamer, characterized by comprising a steamer body, a steamer cover and a steam disperser according to claim 1.

11. A steamer, characterized by comprising a steamer body, a steamer cover and a steam disperser according to claim 2.
